(19) United States
(12) Patent Application Publication
(10) Pub. No.: US 2007/0022005 A1
(43) Pub. Date: Jan. 25, 2007

(54) Method for requesting, displaying, and facilitating placement of an advertisement in a computer network

(76) Inventor: Nader G. Hanna, Campbell, CA (US)

Correspondence Address: SCHNECK & SCHNECK, P.O. BOX 2-E, SAN JOSE, CA, 95109-0005, US

(21) Appl. No.: 11/186,248

(22) Filed: Jul. 21, 2005

(51) Int. Cl. G06Q 30/00

(52) U.S. Cl. 705/14

(57) ABSTRACT

A method and computer-readable storage medium for submitting a request to display an advertisement in a network, facilitating display of an advertisement in a network, and receiving a request to display an advertisement in a network. A request to display an advertisement specifies at least one desired condition for display of an advertisement. The request is reviewed and if the at least one condition is accepted, the advertisement is displayed. Data relating to advertising is also collected and analyzed.

### FIELD OF THE INVENTION

This invention relates to advertising in a computer network, particularly requesting, displaying, and facilitating placement of advertising.

### BACKGROUND ART

Advertising in computer networks such as the Internet has become increasingly profitable and increasingly common. Google's™ AdWords™ is one well-known approach to offering advertising on the Internet. In this approach, text ads appear next to search results on Google™ properties. An advertiser creates ads, specifies which keywords should trigger display of the ads, and indicates the cost-per-click (“CPC”) the advertiser is willing to spend to display the ad. (A “click” occurs when a viewer clicks on the advertisement or the hyperlink associated with the advertisement—in other words, a click determines whether a viewer has interacted with the advertisement.) Based on the cost-per-click and the clickthrough rate (i.e., the percentage of the advertisements displayed which on which a viewer clicks), Google™ determines the ranking of the ad and displays it accordingly.

Another approach to marketing on the Internet, employed by companies such as Overture™, is to bid for ranking. Advertisers submit bids for keywords and the amount they are willing to bid for those keywords (i.e., some amount per click). When an advertiser's bid is highest, the advertiser's site appears first in the search engine rankings when a user searches for that keyword. As with AdWords™, the bid price is paid only when the listing is clicked on to access the site.

Yet another approach to advertising is a cost-per-impression (“CPI”) system in which the party paying for advertising, the “ad customer,” pays each time an ad is “served” (i.e., displayed). (Each time an advertisement is displayed it is counted as one impression.) Using this approach, the ad customers pay for and assume the risk of bandwidth required to serve the ads. This is in contrast to the CPC method, where the displayers of advertising, for instance, search engines, assume the risk for the bandwidth required to serve the ads and only gain revenue from the ad customer when the displayed ad is clicked.

Ideally, in CPC the ad customer only pays when a prospective client is served the ad customer's ad and clicks on the ad, directing the prospective client to the ad customer's Web site. Since the displayer assumes the risk of the bandwidth required to distribute impressions of the advertisement, the displayer typically seeks the highest market price for displaying the ad to pay for the expended bandwidth and also to make a profit.

One disadvantage with the CPC approach is click fraud. Click fraud occurs when parties click on advertisements in order to generate revenue, not out of any interest in the product or service advertised. This drives up costs for the ad customers.

CPI eliminates click fraud since the ad customer is paying for each impression of the ad, not the click rate. However, there are no guarantees that customers will click on their advertisements.

Therefore, it would be desirable to have an improved advertising system.

### SUMMARY

One embodiment is a method for facilitating advertising in a computer network. In this method, a request to display an advertisement is received from an ad customer. The request specifies at least one desired condition for display of the advertisement. This desired condition includes at least one of the following: a minimum number of clicks received per a first selected number of impressions; a maximum number of clicks received per a second selected number of impressions; a first price for displaying the advertisement for a specified time period per a third selected number of impressions; a selected number of searches for a selected search term for a first selected time period; a selected number of times the advertisement is displayed for a second selected time period; a selected number of times the advertisement is clicked on for a third selected time period; or a maximum click through rate per a fourth selected number of impressions. The received request is sent to at least one displayer of advertising. A response from the at least one displayer of advertising is communicated to the ad customer. A computer-readable storage medium stores instructions which, when read by a computer, executes the method.

Another embodiment is a method for displaying advertising in a computer network. A request to display an advertisement is received. The request specifies at least one desired condition of display of an advertisement. This desired condition includes at least one of the following: a minimum number of clicks received per a first selected number of impressions; a maximum number of clicks received per a second selected number of impressions; a first price for displaying the advertisement for a specified time period per a third selected number of impressions; a selected number of searches for a selected search term for a first selected time period; a selected number of times the advertisement is displayed for a second selected time period; a selected number of times the advertisement is clicked on for a third selected time period; or a maximum click through rate per a fourth selected number of impressions. A determination is made as whether to accept the at least one desired condition. The advertisement is displayed if the at least one desired condition is accepted. A computer-readable storage medium stores instructions which, when read by a computer, executes the method.

### BRIEF DESCRIPTION OF THE DRAWINGS

FIG. 1 is a block diagram of a network configuration of one embodiment in which the invention operates.

FIG. 2a is an exemplary tabular presentation of data in one embodiment of the invention.

FIG. 2b is an exemplary graphical presentation of data in one embodiment of the invention.

FIG. 3 is an exemplary form for placing a request for advertising in one embodiment of the invention.

FIG. 4 is a flowchart of an exemplary advertising campaign in accordance with the invention.

### DETAILED DESCRIPTION

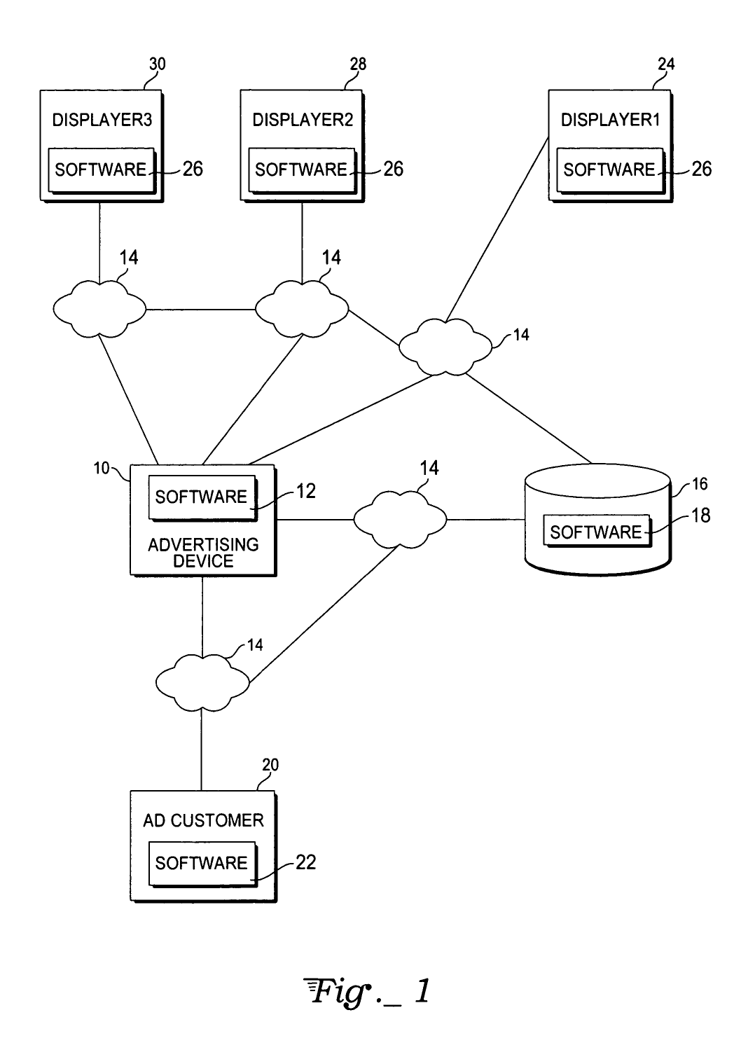

In FIG. 1, an ad customer device 20 is connected via a network connection 14 (such as the Internet, though other network connections may be employed in different embodiments) to an advertising device 10 in one embodiment. Various ad customers 24, 28, 30 of advertising are connected via a network connection 14 to the advertising device. In one embodiment, at least one of the ad customers 24, 28, 30 is a search engine, such as Yahoo™ or Google™, a program designed to find information stored on a system or computer. An ad customer displays advertisements. Those ad customers which are search engines generally display advertisements with results of searches when a search term, or keyword, has been associated with an advertisement; in other embodiments, other approaches to displaying advertising may be employed.

In one embodiment, the advertising device 10 intermediates between the ad customer 20 and the ad customers 24, 28, and 30. As will be discussed in greater detail below, the device 10 facilitates a bidding process between the ad customer 20 and the advertisement displayers 24, 28, 30 to determine if, where, and/or under which conditions an ad customer's 20 advertisement will be displayed.

In another embodiment, a database 16 of advertising data is connected to the advertising device 10 either directly or via network connection 14. (In other embodiments, several databases may be employed or the database may be located on the same device as the advertising device 10.) This database 16 has software 18 for database operations as well as analyzing data stored in the database 16. At least some of the data stored at the database is received from at least one of advertising displayers 24, 28, 30; the data may be sent to the database directly by the displayer 24, 28, 30 (for instance, in one embodiment an application programming interface (“API”) is used to collect data from the displayers and send it to the database 16, although other methods of sending data to the database may be employed in other embodiments). As will be discussed below, the data stored in the database 16 and any analysis of that data may be accessed by an ad customer 20 and used to form a bid to display advertising.

The advertising device 10 may be any computing device located in a network. In addition to running software to control device and network operations, it also runs software 12 related to advertising operations. As is well-known in the art, software is a computer-readable storage medium (including compact disc, computer diskette, and computer memory, etc.) with code, or instructions, which, when read and executed by a computer, causes the computer to perform a process or task. This software 12, for instance, accepts and processes requests for advertisements from ad customers 20 and accepts and processes responses from displayers 24, 28, 30. The software 12 (or the database 16) may also store information on an ad customer's previous or on-going advertising campaign. The software 12 can also communicate information to the ad customers 20 and displayer 24, 28, 30, for instance through e-mail through other communication methods may also be used. In one embodiment, the software 12 forms a portal which may be accessed through the World Wide Web and offers advertising services, discussed in greater detail below, to both ad customers 20 and displayers 24, 28, 30. As is known in the art, portals are built using portlets, reusable Web components written in markup languages (such as HTML and XML). The portlets are held in containers in the portal page. The portlets display information to the portal users. Data stored and analyzed by the database 16 may also be accessed through the portal.

The ad customer 20 may be any network device. In addition to software for running the device as well as network operations, the ad customer 20 may also be running software 22 for advertising operations. This software 22 may include a user interface to the advertising portal. (In another embodiment, the ad customer user may use the advertising portal simply by accessing the advertising portal through a browser such as Microsoft™ Internet Explorer™ or Netscape Navigator™.) The user interface may be downloaded from the advertising portal in one embodiment or may be installed on the ad customer device in any other manner known in the art.

The displayer devices 24, 28, 30 are any network devices. As noted above, these devices may be associated with search engines such as Google™, Yahoo™, etc. In addition to software for running the device and handling network operations, the devices 24, 28, 30 may also be running software 26 related to advertising operations. (In one embodiment, a user of the displayer device 24, 28, 30 may access the advertising portal through a browser running on the displayer device 24, 28, 30.) This software 26 may include a user interface for accessing the advertising portal similar to that discussed above for the ad customer 20. The software may also include an application programming interface (“API”) which is used to transmit data related to searches and/or advertising at the displayer device to the database 18. The software 26 may be obtained from the advertising device 10 or otherwise installed at the displayer device in any manner known in the art. In another embodiment, the advertising portal may be accessed via an API at the advertising device.

As noted above, the data sent from a displayer device 24, 28, 30 to the database 16 relates to searches and/or advertising at the displayer device. (In another embodiment, any device which contains information about either searches or advertising may send information to the database 16.) The data sent to the database may include, but is not limited to, any one of the following: search terms; the geographic locations/designation from which searches or ad clicks originate; bid price data for advertisements (including the search terms for which the bid is made); time designations; ad placement; ad performance (for instance, the advertisement's overall click through rate, the click through rate at different times, etc.); search velocity (the number of ad term searches per units of time (including discrete time periods such as hours, days, weeks, etc.); click velocity (the number of times a particular ad is clicked on per unit of time (including discrete time periods such as hours, days, weeks, etc.); and/or click velocity (the number of times a particular ad is clicked per unit of time (including discrete time periods such as hours, days, weeks, etc.).

This data is stored at the database and analyzed. In addition to compiling statistics about the search terms and advertisements across the network or at particular display devices, graphical representations of the data or historical trends may be made available, for instance to an ad customer interested in placing an advertisement or an advertisement displayer. Therefore, it is possible to track performance of an advertisement over the network or for a particular displayer over time, in certain geographical locations, at particular times, etc. It is also possible to monitor the performance of a competitor's advertisement(s) or one's own advertisement(s) in this fashion.

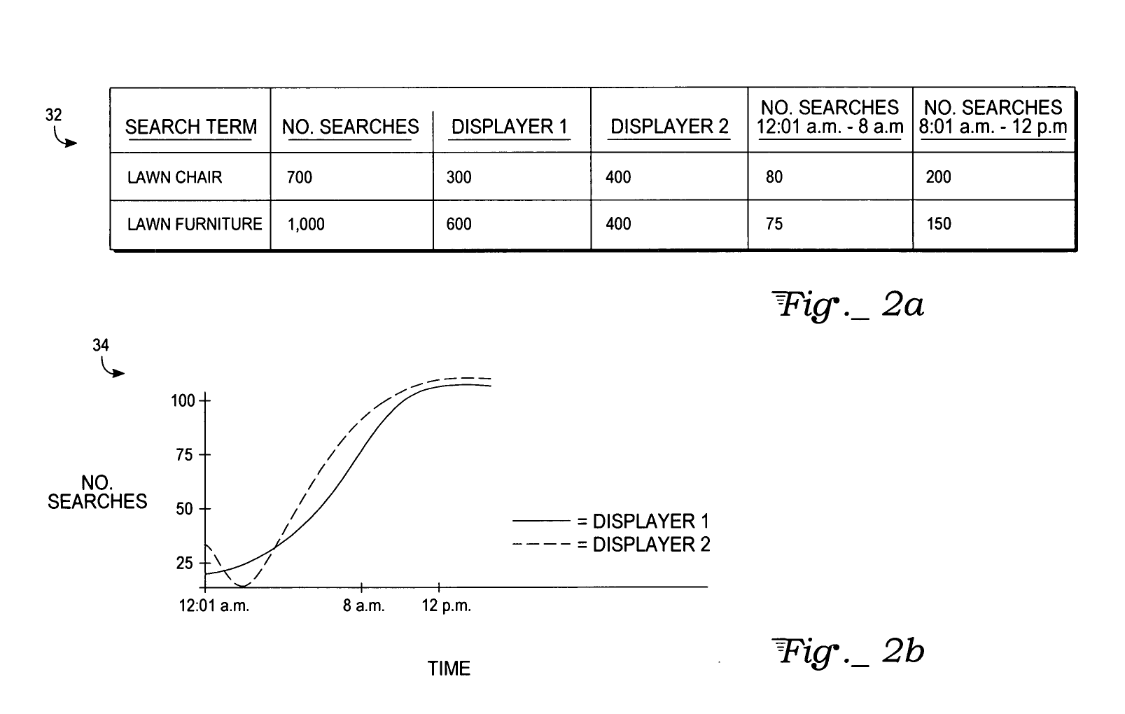

The data and analysis of the data may be used by an ad customer to either place a bid for advertising or monitor an existing advertising campaign. This data/analysis may be accessed through either the user interface or at the advertising portal. Data and analysis may be presented in a number of ways. In FIG. 2, if an ad customer wants to know the number of searches for the terms “lawn chair” and “lawn furniture” over a 12-hour period, a table 32 of results may be presented to the ad customer showing the total number of searches, the number of searches at displayer 1 and displayer 2, and the number of searches performed at different times (in this case, 12:01 a.m.-8 a.m. and 8:01 a.m.-12 p.m.). In FIG. 2b, a graphical comparison 34 of the number of searches for the term “lawn chair” at different times at different displayers may be presented. (The data and analysis presentations offered in FIGS. 2a and 2b are illustrative only and different types of analyses and data presentations may be performed.) Therefore, if an ad customer were interested in determining where an advertisement for lawn chairs might get the most exposure between 12:01 a.m. and 8 a.m., the comparison would indicated that displayer 2 is most effective around 12:01 a.m. but that displayer 1 shows a steadily increasing number of searches throughout that time period. Advertisement performance may be similarly documented by checking click through rates, sales, etc.

An ad customer may place a request for an advertisement through the advertising portal. In one embodiment, the request for advertising provides an opportunity for the ad customer to be guaranteed a level of performance for the advertisement. By specifying a minimum number of required clicks, the ad customer would indicate the minimum number of clicks necessary before the ad customer pays the full price of displaying the advertisement. For instance, if the request specifies ten minimum clicks per thousand impressions and only five clicks are received after the thousand impressions are served, the ad customer would only pay a percentage of the price indicated in the request (the percentage could either be indicated in the request or each displayer could set percentages). For example, if the amount paid were a direct percentage of the number of clicks received compared to the minimum number of clicks requested (when the minimum number is not exceeded), and, using the example listed above, five clicks were received instead of the requested ten, the ad customer would pay only half the agreed-upon price for displaying the advertisement.

The ad customer may also specify a maximum number of clicks in the request. This would represent the minimum number of clicks the ad customer requires to be satisfied with the campaign performance and would allow the displayer to stop displaying the advertisement. For instance, if the request specifies twenty maximum clicks per thousand impressions, and twenty clicks are received after nine hundred impressions, the displayer could stop displaying the advertisement while the ad customer would still have to pay the agreed-upon price. If a number of maximum clicks is not specified, all the impressions are served. In another embodiment, the maximum number of clicks may represent the maximum number of clicks for which the ad customer is willing to pay; if the number is exceeded, the ad customer will not have to pay for those clicks in excess of the maximum.

In one embodiment, when a maximum number of clicks is specified, the ad customer may also specify a maximum click through rate. This allows the ad customer to specify a tolerance level for a maximum number of clicks per number of impressions. For instance, if the ad customer wishes to have 1000 impressions and a maximum number of clicks of 20, the ad customer can specify a maximum click through rate of 2% per 100 impressions, 2% per 150 impressions, 2% per 1000 impressions, etc. In other words, the maximum click through rate per any number of impressions may be indicated.

The above approaches, where a minimum and/or maximum number of clicks (as well as a maximum click through rate) is specified, can benefit both the ad customer and the displayer. The ad customer benefits from receiving a guaranteed number of clicks or a price reduction while the displayer benefits from being able to terminate an ad when the maximum number of clicks is exceeded. Click through fraud may also be reduced through this approach since the pricing model moves from a CPC model to more of a CPI model, since display of the advertisement can be stopped after either the maximum number of clicks or the maximum click through rate for a number of impressions is exceeded or the ad customer will not have to pay if either the maximum number of clicks or the maximum click through rate is exceeded. In other words, the ad customer is protected from click through fraud by having a mechanism which will protect against unusually high click through rates which may be an indication of click through fraud; for instance, if a maximum click through rate is specified for a relatively small number of impressions, such as 100, the ad customer is protected from having to pay for a large number of clicks for a small number of impressions that may be due to click through fraud rather than actual consumer activity. This minimizes the cost to the ad customer. The displayer is guaranteed a cost per impression and does not have to assume the risk of bandwidth associated with serving the ad once the maximum number of clicks is exceeded; in addition, the displayer can offer some assurance to the ad customer that the ad customer will be protected from click through fraud.

In another embodiment, the ad customer may “lock-in” pricing for a specified time period. This includes times, dates, or ranges of times and/or dates, with any starts and stops between the initial start date and stop date. This approach allows the ad customer to arrange advertising at future dates. This pricing feature may operate on its own or in combination with any of the other parameter described above and below.

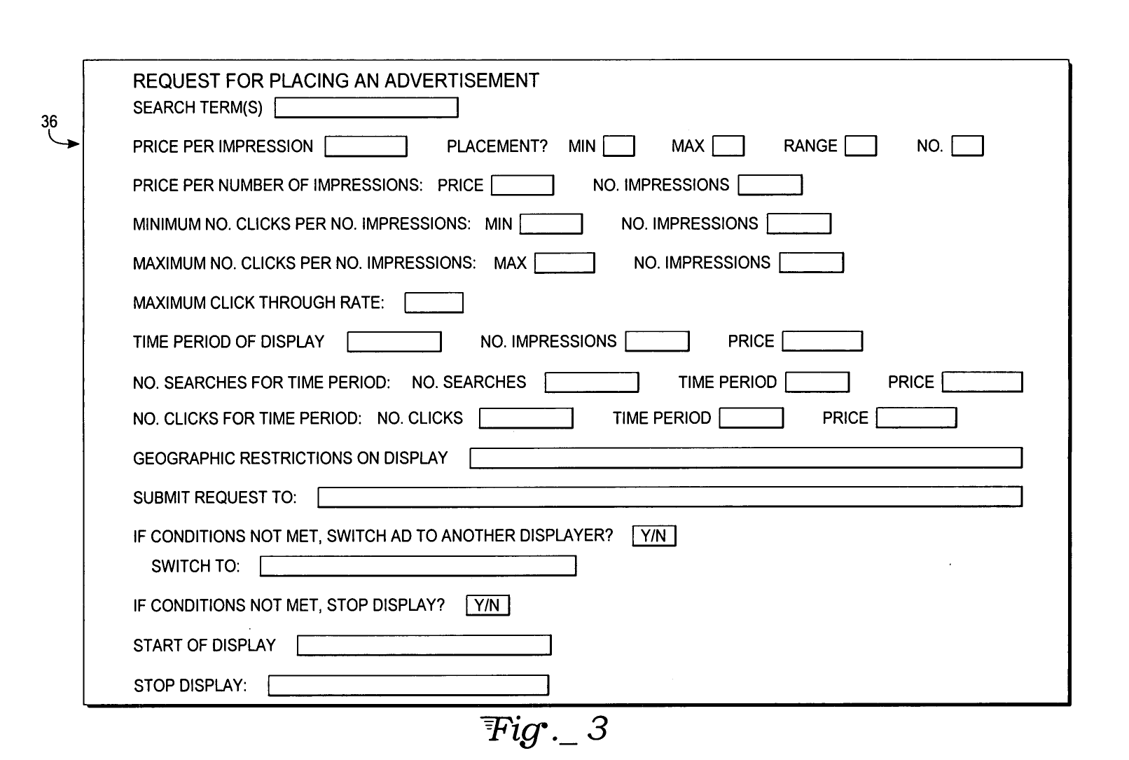

The request may be filled in using either the user interface or the advertising portal, depending on the embodiment. In FIG. 3, an exemplary form for a request for placing an advertisement allows the ad customer to specify various parameters. (The format and parameters in the form are presented for exemplary purposes only. Any other type of form or message indicating different parameters/combinations of parameters may be used in various embodiments.) The request may specify a number of parameters or desired conditions including, but not limited to, the following: search terms associated with the advertisement; price per impression; a desired placement (i.e., a placement of the advertisement which is deemed most conspicuous by the displayer); a minimum desired placement (i.e., lowest acceptable placement); a maximum desired placement (i.e., highest acceptable placement); a range of placements (indicating the ad customer wishes a placement that ranges between a minimum and maximum placement); a price per number of impressions; the minimum number of clicks per a selected number of impressions; the minimum number of clicks per a selected number of impressions served during a specified time period (i.e., certain hours, days, a range of dates, etc.); the maximum number of clicks per a selected number of impressions; the maximum number of clicks per a selected number of impressions served during a specified time period (i.e., certain hours, days, a range of dates, etc.); a maximum click through rate; a desired time period of display (i.e., certain hours, days, a range of dates, etc.); the price to display a selected number of impressions for that desired time period; a number of searches for the search term for a time period; the time period and price for the number of searches for the time period; geographic restrictions on the display of the advertisement; a price per click one or more displayers to which the request should be submitted; an indication of whether, if any of the desired conditions are not met, the ad should be switched to another displayer, and if so, which displayer should begin displaying the ad; an indication of whether, if any of the desired conditions are not met, display of the advertisement should be stopped; an indication of when the display of the advertisement should be started (i.e., a time, date, or some other condition that should be met); an indication of when the display of the advertisement should be stopped (i.e., a time, date, or some other condition that should be met); a predetermined time interval after which the advertising campaign may be altered; whether terms of the advertising campaign may be altered; etc. The request may also indicate a price per click for any of the parameters discussed above.

The request is submitted to a displayer of advertising. This may be done either by the advertising portal or it may be submitted directly to the displayer by the ad customer. The displayer may receive the request through the API. The displayer then reviews the request and decides whether to accept the request. In one embodiment, the displayer may modify the condition(s) (i.e., change the price, number of impressions, minimum number of clicks, etc.) in the request and have the ad customer determine whether the modified conditions are acceptable.

Once both the displayer and the ad customer agree on conditions of display, the advertisement campaign begins. The ad customer delivers the advertisement to the displayer (in some embodiments, the advertisement could also be submitted with the request), which then displays the advertisement. The advertisement campaign may be monitored by the ad customer and/or some designated third party to track performance and determine whether the conditions of the campaign are being satisfied. (This may be done, for instance, by assigning a unique identification to the advertising and tracking performance of the advertisement through that number. Other methods for tracking performance may also be used.) This information may be sent from the displayer to the database (for instance, through the API discussed above) and then presented to the ad customer and/or the designated third party or it may be presented directly to the ad customer and/or the designated third party. The information may also be tracked through the advertising portal.

In another embodiment of the invention, a displayer may solicit advertising from an ad customer by submitting a request to the ad customer. A request, similar to that discussed above in FIG. 3, may be submitted to an ad customer; this request could detail at least one condition of display of an advertisement. The ad customer may accept or may modify the request; once a condition or conditions of display are accepted, the advertisement will be displayed. The request submitted to the ad customer may be tailored for specific search terms, or keywords, known to be of interest to the ad customer. This information may be obtained from the database. Solicitations based on keywords may be sent periodically customers as market conditions change.

If conditions are not satisfied, the ad customer has several options. As discussed above, the ad customer may pay a reduced price or may transfer the advertising campaign to another displayer. These options may be indicated in the request or may be part of a standard agreement offered by the displayer.

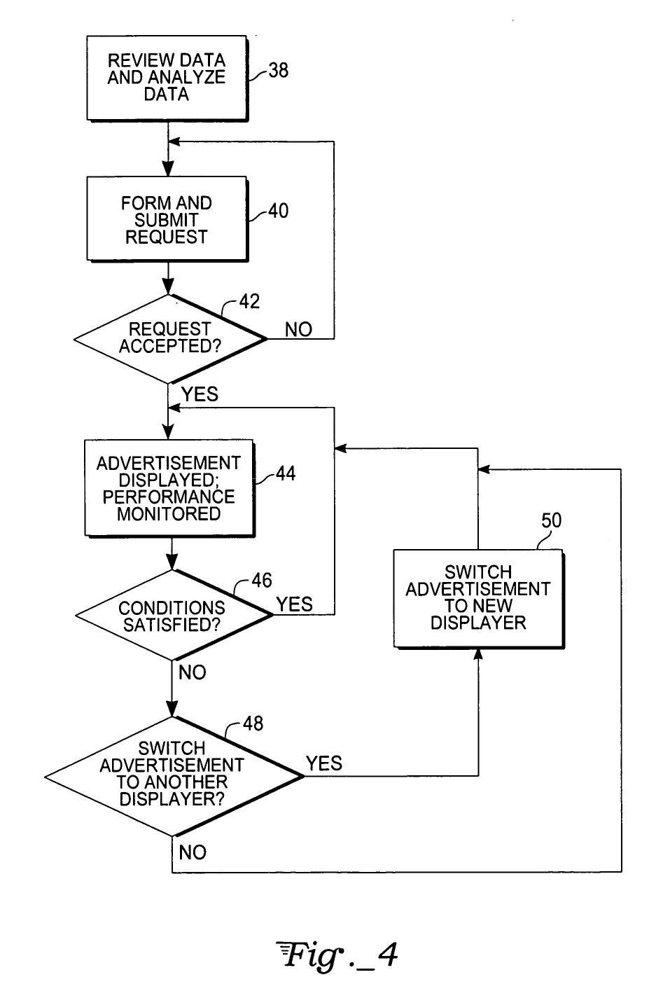

An overview of an exemplary advertising process is indicated in FIG. 4. An ad customer reviews and analyzes data related to a potential advertising campaign (block 38). The ad customer then forms and submits a request to display advertising to the advertising portal (block 40). The advertising portal then submits the request to the displayers identified in the request. The displayers review the request and indicate to the advertising portal whether the bid is accepted (block 42). If the request is not accepted (block 42), the ad customer is notified by the advertising portal, and the ad customer can create another request (block 40).

If the request is accepted by the displayer (block 42), the advertisement campaign begins and the advertisement is displayed and its performance is monitored (block 44). The ad customer or a designated third party (which may include the advertising portal) can determine whether the conditions of the request are being satisfied (block 46). If the conditions are satisfied (block 46), the campaign continues (block 44). However, if conditions are not satisfied (block 46), the ad customer or third party may decide whether to switch the advertisement to another displayer (block 48). If a switch is made (block 48), the advertisement is displayed by the new displayer and the performance is monitored (block 44). However, if no switch is made (block 48), the advertisement continues to be displayed and the performance is monitored (block 44) as discussed above. This example is exemplary only and, as noted above, there are many parameters and different implementations of the advertising process which may be employed.

In other embodiments of the invention, the ad customers and displayers may communicate directly without the intervention of the advertising portal. In still other embodiments, the advertising portal may still intermediate between the two at various levels of transparency (i.e., the advertising portal may handle communications between the ad customers and the displayers; however, this will not be apparent to either the ad customers or displayers). Furthermore, the various services offered by the advertising portal, such as delivering data and analysis from various sources to the ad customer, may also be transparent to the ad customer and the displayer.

Although the present invention has been described in terms of specific exemplary embodiments, one skilled in the art will recognize that variations and additions to the embodiments can be made without departing from the principles of the present invention.

What is claimed is:

1. A method for displaying advertising in a computer network, the method comprising:
a) receiving a request to display an advertisement, the request specifying at least one desired condition of display of an advertisement, the at least one desired condition including at least one of the following:
i) a minimum number of clicks received per a first selected number of impressions;
ii) a maximum number of clicks received per a second selected number of impressions;
iii) a first price for displaying the advertisement for a specified time period per a third selected number of impressions;
iv) a selected number of searches for a selected search term for a first selected time period;
v) a selected number of times the advertisement is displayed for a second selected time period;
vi) a selected number of times the advertisement is clicked on for a third selected time period; or
vii) a maximum click through rate per a fourth selected number of impressions.
b) determining whether to accept the at least one desired condition, wherein the advertisement is displayed if the at least one desired condition is accepted.

2. The method of claim 1 wherein the at least one desired condition further includes at least one of the following:
a) a second price per impression of the advertisement;
b) a third price per a fifth selected number of impressions;
c) a fixed placement for the advertisement;
d) a minimum acceptable placement for the advertisement;
e) a maximum acceptable placement for the advertisement;
f) a range of acceptable placements for the advertisement;
g) at least one search term which will prompt the display of the advertisement;
h) geographic restrictions on where the advertisement is displayed;
i) a fourth selected time period in which to display the advertisement; or
j) a fourth price per click.

3. The method of claim 1 wherein the request further specifies at least one displayer of advertisements to which the request will be submitted.

4. The method of claim 1, the request further comprising an indication that if the at least one desired condition is not satisfied, the advertisement should not be displayed.

5. The method of claim 1 further comprising changing the at least one desired condition after display of the advertisement starts.

6. The method of claim 1, the request further comprising an indication that if the at least one desired condition is not satisfied, a reduced price will apply.

7. The method of claim 1, the request further comprising an indication that display of the advertisement will stop if either the maximum number of clicks or the maximum click through rate is exceeded.

8. The method of claim 1 further comprising modifying the at least one desired condition in a response to the request to display the advertisement.

9. The method of claim 8 further comprising displaying the advertisement if the modification of the at least one desired condition in the response to the request is accepted.

10. The method of claim 8 wherein the response specifies when to stop display of the advertisement if the at least one condition is not satisfied.

11. The method of claim 8 wherein the response or received request indicates when to start display of the advertisement.

12. The method of claim 1 further comprising providing data related to advertising, the provided data comprising at least one of the following:
a) search terms;
b) geographic origins of searches;
c) bid prices of advertisements associated with at least one search term;
d) time of searches;
e) placement of advertisements;
f) clicks for at least one advertisement displayed by a displayer of advertising; or
g) time of clicks for at least one advertisement displayed by the displayer of advertising.

13. The method of claim 1 further comprising changing the at least one desired condition after display of the advertisement starts.

14. The method of claim 1 further comprising receiving a request to change the at least one desired condition after display of the advertisement starts.

15. The method of claim 12 further comprising determining whether to accept the change to the at least one desired condition after display of the advertisement starts.

16. A computer-readable storage medium storing instructions that, when executed by a computer, perform a method for method for displaying advertising in a computer network, the method comprising:
a) receiving a request to display an advertisement, the request specifying at least one desired condition of display of an advertisement, the at least one desired condition including at least one of the following:
i) a minimum number of clicks received per a first selected number of impressions;
ii) a maximum number of clicks received per a second selected number of impressions;
iii) a first price for displaying the advertisement for a specified time period per a third selected number of impressions;
iv) a selected number of searches for a selected search term for a first selected time period;
v) a selected number of times the advertisement is displayed for a second selected time period;
vi) a selected number of times the advertisement is clicked on for a third selected time period; or
vii) a maximum click through rate per a fourth selected number of impressions;
b) determining whether to accept the at least one desired condition, wherein the advertisement is displayed if the at least one desired condition is accepted.

17. The computer-readable storage medium of claim 16 wherein the at least one desired condition further includes at least one of the following:
a) a second price per impression of the advertisement;
b) a third price per a fifth selected number of impressions;
c) a fixed placement for the advertisement;
d) a minimum acceptable placement for the advertisement;
e) a maximum acceptable placement for the advertisement;
f) a range of acceptable placements for the advertisement;
g) at least one search term which will prompt the display of the advertisement;
h) geographic restrictions on where the advertisement is displayed;
i) a fourth selected time period in which to display the advertisement; or
j) a fourth price per click.

18. The computer-readable storage medium of claim 16 wherein the request further specifies at least one displayer of advertisements to which the request will be submitted.

19. The computer-readable storage medium of claim 16, the request further comprising an indication that if the at least one desired condition is not satisfied, the advertisement should not be displayed.

20. The computer-readable storage medium of claim 16, the method further comprising changing the at least one desired condition after display of the advertisement starts.

21. The computer-readable storage medium of claim 16, the request further comprising an indication that if the at least one desired condition is not satisfied, a reduced price will apply.

22. The computer-readable storage medium of claim 16, the request further comprising an indication that display of the advertisement will stop if either the maximum number of clicks or the maximum click through rate is exceeded.

23. The computer-readable storage medium of claim 16, the method further comprising modifying the at least one desired condition in a response to the request to display the advertisement.

24. The computer-readable storage medium of claim 23, the method further comprising displaying the advertisement if the modification of the at least one desired condition in the response to the request is accepted.

25. The computer-readable storage medium of claim 23 wherein the response specifies when to stop display of the advertisement if the at least one condition is not satisfied.

26. The computer-readable storage medium of claim 23 wherein the response or received request indicates when to start display of the advertisement.

27. The computer-readable storage medium of claim 16, the method further comprising providing data related to advertising, the provided data comprising at least one of the following:
a) search terms;
b) geographic origins of searches;
c) bid prices of advertisements associated with at least one search term;
d) time of searches;
e) placement of advertisements;
f) clicks for at least one advertisement displayed by a displayer of advertising; or
g) time of clicks for at least one advertisement displayed by the displayer of advertising.

28. The computer-readable storage medium of claim 16, the method further comprising changing the at least one desired condition after display of the advertisement starts.

29. The computer-readable storage medium of claim 16, the method further comprising receiving a request to change the at least one desired condition after display of the advertisement starts.

30. The computer-readable storage medium of claim 27, the method further comprising determining whether to accept the change to the at least one desired condition after display of the advertisement starts.
